(19) United States
(12) Patent Application Publication
(10) Pub. No.: US 2017/0013991 A1
(43) Pub. Date: Jan. 19, 2017

(54) TWO-TIER HEAT TRANSFER SYSTEM AND METHOD FOR ITS USE

(71) Applicant: Unitherm Food Systems, Inc, Bristow, OK (US)

(72) Inventors: David Howard, Bristow, OK (US); Austen Laur, Tulsa, OK (US)

(21) Appl. No.: 14/800,866

(22) Filed: Jul. 16, 2015

(51) Int. Cl. A47J 27/04; A23L 1/01

(52) U.S. Cl. CPC A47J 27/04; A23L 1/0121; A47J 2027/043; A23V 2002/00

(57) ABSTRACT

A two-tier heat transfer system and method for its use includes a first cooking medium delivery system which is controlled by a measured state of a commercial oven's cook chamber relative to a predetermined set point and a second cooking medium delivery system which is not controlled by the measured state or set point. Each delivery system can deliver a same or different cooking medium than the other, at the same or different performance characteristics, and in a different type of flow pattern.

### BACKGROUND OF THE INVENTION

This invention in the field of commercial ovens and, more particularly, with systems and methods intended to deliver cooking medium into the cooking chambers of those ovens and control the cooking environment.

The market for commercial ovens has evolved over the last 20 years. Heat transfer systems commonly used in connection with those ovens include convection, impingement, and hot air. During the cooking process, steam or moisture can be released from the product and this release can be supplemented by injecting additional steam into the hot air of the cooking chamber. By monitoring a humidity reading of the cooking chamber—(e.g., relative humidity, dew point, wet-bulb temperature, water vapor content), the steam can be injected in such a way as to create a controlled environment.

Companies such as Foodtech, GEA Heat and Control, JBT and Unitherm offer this type of system as a matter of routine practice with their commercial ovens. However, no prior art oven has two heat sources being delivered with one source subordinate to the other.

### SUMMARY OF THE INVENTION

The essence of this invention is two independent delivery systems, one of which is controlled by a measured state of the cook chamber relative to a predetermined set point, the other of which is not controlled by that measured state or set point, with each delivery system delivering a same or different cooking medium to the product in a different type of flow (and perhaps at a different time, temperature, pressure, rate or volume) than the other.

In a preferred embodiment of the invention, a first cooking medium is delivered into the cook chamber of the oven dependent on a measured state of the cook chamber relative to a predetermined set point of the cook chamber. A second cooking medium—which could be the same type of cooking medium (e.g., steam, which could range from saturated steam to super-heated steam), at the same or different temperature and pressure as the first, or from a same or different supply as the first—is delivered into the cook chamber independent of the measured state of the cook chamber relative to the predetermined set point. Preferably, the first cooking medium is delivered as a non-impinging flow and the second cooking medium is delivered as an impinging flow.

After being delivered, an unabsorbed portion of the second cooking medium can combine in the cook chamber with a delivered portion of the first cooking medium. The delivered volume of the second cooking medium should be such that the second cooking medium alone does not cause the measured state of the cooking chamber to rise above the predetermined set point. The measured state and predetermined set point could be a temperature.

A preferred embodiment of a system that makes use of the inventive concept is one having a first delivery system in communication with a first source of cooking medium and arranged to deliver the first source of cooking medium into the cook chamber; a second delivery system with means to control a second source of cooking medium and arranged to deliver the second source of cooking medium into the cook chamber; and means for controlling the delivery of the first source of cooking medium relative to a measured state of the cook chamber and a predetermined set point of the cook chamber. The measured reading of the cook chamber and the predetermined set point does not affect the delivery of the second source of cooking medium.

The first and second cooking medium sources can be different cooking mediums or can be from a same or different supply of cooking medium. Preferably, the first delivery system is arranged for non-impinging flow and the second delivery system is arranged for impinging flow. The measured state and the predetermined set point could be any parameter of the cook chamber preferable for control of the first delivery system, including but not limited to temperature.

A preferred embodiment of a commercial oven which makes use of the inventive concept has a first delivery system arranged to deliver a first cooking medium in a non-impinging flow pattern into a cook chamber and a second delivery system arranged to deliver a second cooking medium in an impinging flow pattern into the cook chamber. A first means for controlling the first delivery system controls delivery relative to a measured state of the cook chamber and a predetermined set point of the cook chamber. A second means for controlling the second delivery system controls delivery independent of the measured reading of the cook chamber and the predetermined set point. The second means for controlling limits delivery of the second cooking medium so as not to exceed the predetermined set point by itself. The first and second controlling means are of a kind known in the art, such as a programmable controller and its equivalent.

### BRIEF DESCRIPTION OF THE DRAWINGS

FIG. 1 is a cross-section view of a preferred embodiment of a spiral oven configured to practice the system and method of this invention. A first delivery system, controlled in relation to a measured state of the cook chamber relative to a predetermined set point of the cook chamber, provides steam or cooking medium in a non-impinging flow pattern to the cook chamber. A second delivery system, independent of the first and not controlled in relation to the measured state or predetermined set point, provides steam or cooking medium in an impinging flow pattern directly to the food product to be cooked.

FIG. 2 is an enlarged view of a portion of the second delivery system of FIG. 1.

FIGS. 3A & 3B are examples a cone or nozzle arranged for impinging flow.

FIGS. 4A to 4C are examples of a cone or nozzle arranged for non-impinging flow.

### ELEMENTS AND NUMBERING USED IN THE DRAWINGS AND DETAILED DESCRIPTION

10 Cook chamber
20 First delivery system
21 First source of cooking medium
23 Cone or nozzle
25 Non-impinging flow
30 Second delivery system
31 Second source of cooking medium
33 Cone or nozzle
35 Impinging flow

### Definitions

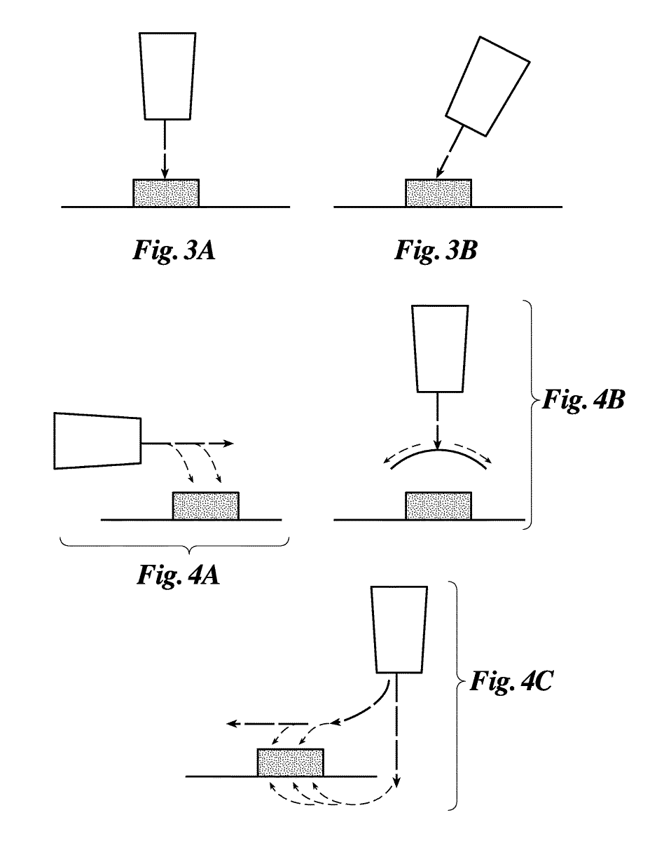

For the purpose of this disclosure, the following definitions apply:
Cook or cooking chamber—an area located between the inlet and outlet openings of an oven in which food product is exposed to a cooking medium.
Cone or nozzle—a device which directs steam or cooking medium in a desired direction of flow within the cooking chamber and, depending on the cone or nozzle's configuration, can produce a venturi effect toward or at the outlet opening of the cone or nozzle.
Non-impinging flow—a flow of steam or cooking medium that originates from a nozzle or cone oriented relative to the cook belt so that the flow moves laterally over or under the product or comes into contact with the top or bottom surface of the product because of a circulating or indirect (including deflected) air flow pattern created alone or in part by the cone or nozzle. FIGS. 4A to 4C provide some examples of non-impinging flow.
Impinging flow—a flow of steam or cooking medium that originates from a cone or nozzle oriented relative to the cook belt so that the flow comes into contact with the top or bottom surface of the product because of a linear or direct flow pattern created alone or in part by the cone or nozzle. FIGS. 3A and 3B provide some examples of impinging flow.
First delivery system—a system in communication with a first source of steam or cooking medium that provides a non-impinging flow of steam or cooking medium relative to a predetermined set point of the cooking chamber. The first source of steam or cooking medium may originate from its own supply system or the same supply system as for the second delivery system, and can be a different steam or cooking medium than the first source.
Second delivery system—a system in communication with a second source of steam or cooking medium that provides a constant or interval (intermittent) impinging flow of steam or cooking medium. The second source of steam or cooking medium may originate from its own supply system or the same supply system as the first delivery system, and can be a different steam or cooking medium than the first source.

### DETAILED DESCRIPTION OF THE PREFERRED EMBODIMENTS

Preferred embodiments of a two-tier heat transfer system will now be described using, by way of a non-limiting example, steam cooking sausage patties. A person of skill in the art would understand that different products could be cooked using the system and method and that cooking mediums other than steam could be employed. The scope of the invention is defined by the claims which follow this description, including elements and steps equivalent to those listed. The essence of the invention is two independent delivery systems, one of which is controlled by a measured state of the cook chamber relative to a predetermined set point, the other of which is not controlled by that measured state or set point, with each delivery system delivering a same or different cooking medium to the product in a different type of flow (and perhaps at a different time, temperature, pressure, rate or volume) than the other.

Preferably, a commercial oven operates at a constant temperature to maintain a fixed and repeatable cooking environment. For this reason, prior art ovens rely on a temperature probe to monitor and help control the supply of energy (steam or cooking medium) to the cook chamber. Steam-cooking a food product such as sausage patties in a spiral steamer oven is provided as an example of this kind of monitoring and control.

In a common cooking arrangement to steam-cook the patties, the spiral steamer oven is set to operate at a predetermined set point such as 205° F. (about 96.1° C.). Steam is convected into or through the cooking chamber of the oven by a circulation fan which carries the steam into the cooking chamber and may pass through cones or nozzles to create a non-impinging flow. The temperature probe(s)—which can be attached to a steam supply line or implemented directly into the processing equipment—communicates with a modulating valve controlling the flow of steam to the fan area by altering valve position to reach and maintain a predetermined set point.

Those skilled in the art understand that the patties, like other food products, can be cooked in different zones within the spiral steamer oven and to different conditions. The sausage patties could be par-cooked, fully cooked, or heat treated in a first zone of the oven and then finished in a second zone of the oven, with each zone corresponding to a different cooking phase. Regardless of the cooking method, feedback from the probe dictates control of the opening and closing of the valve relative to the set point and a single source of steam is relied upon.

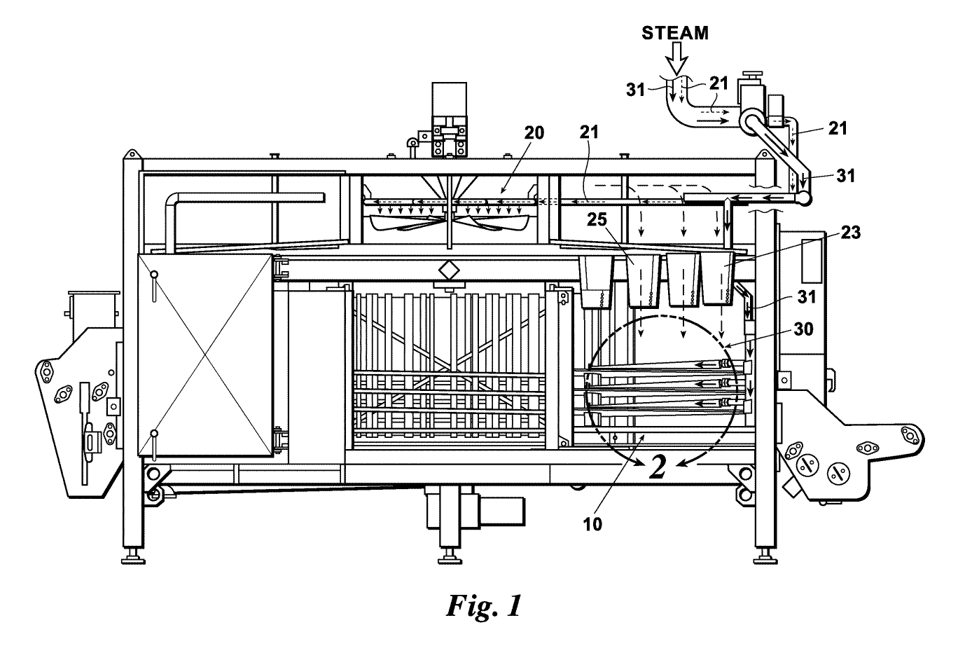

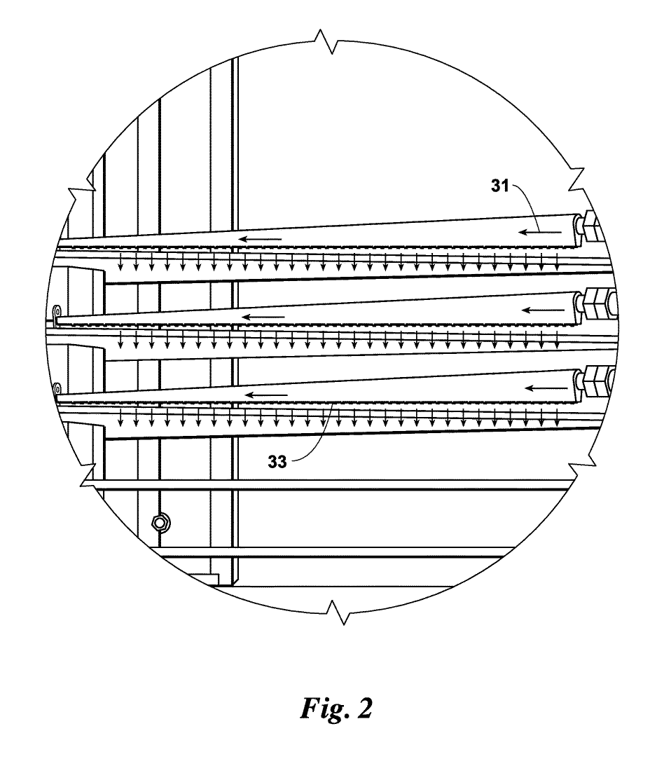

Referring now to FIGS. 1 and 2, a preferred embodiment of a system and method according to this invention relies upon two delivery systems 20, 30 of steam or cooking medium. The steam or cooking medium could originate from the same supply system then separate into independently delivered sources, or the cooking mediums could originate from separate supply systems.

Regardless of whether the same or different supply systems are used, the first source 21 of steam or cooking medium is in communication with a first delivery system 20 that convects the steam or cooking medium into the cooking chamber through cones or nozzles 23 in the same or substantially same way as the non-impinging flow of the common cooking arrangement. The second source 31 of steam or cooking medium is in communication with a second delivery system, subordinate to the first, which convects the steam or cooking medium through cones or nozzles 33 as an impinging flow. Because this second source 31 should not over-supply energy to the cooking chamber 10, the second source 31 must always be throttled so that it does not oversupply energy or overtake the first source 21.

In a preferred embodiment of the second delivery system 30, cones or nozzles 33 are suspended between the tiers of the spiral cook belt and over the food product, or under the belt and below the food product, or both over the product and under the belt (see e.g., U.S. Pat. No. 8,646,383 which is hereby incorporated by reference). The steam or cooking medium from these nozzles 33 provide an impinging flow which contacts the surface of the product to be cooked.

Because the steam or cooking medium is under pressure until it is released by the cone or nozzle 33, and because the temperature of the steam exiting the cone or nozzle 33 is hotter than the set point, the energy transfer to the product is greater than the transfer from convected or non-impinging flow steam alone. A flash, thermal heat transfer results. This is only an example. Other applications can involve steam or cooking medium temperature above the set point and energy transfer to the product may not be greater than that from the first source. Other applications could use flame from a burner directly contacting the product. Still other applications could use smoke to impart flavor to, dry, or cure the product.

To provide a non-limiting example of the inventive method, and returning to steam-cooking sausage patties in a spiral steamer oven with a predetermined set point of 205° F. (about 96.1° C.), in one experiment steam convection alone raised the core temperature of the sausage patties from 28° F. to 115° F. (from about −2.2° C. to 46.1° C.) in 90 seconds. Steam convection with the addition of exposure to constant steam impingement flow (totaling approximately 8 seconds out of the 90 second cook) raised the core temperature of the sausage patties from 28° F. to 165° F. (from about −2.2° C. to 73.9° C.) in that same amount of time.

In this example, exposure duration—time under cone or nozzle—was controlled by belt speed but could also be adjusted by changing the number of nozzles used or by altering the nozzle's design to create a wider or narrower opening. Energy transfer rate could also be altered by increasing or decreasing steam pressure (temperature) and velocity exiting the nozzle.

Surprisingly, the core temperature in the patty rose very rapidly, exhibiting an increase in energy transfer rate corresponding to approximately 6.25° F. (3.47° C.) per second of direct exposure to steam impingement increase over steam convection alone—i.e. a delta of 50° F. or 27.78° C. for the 8 seconds of impingement: 165° F. or 73.89° C. final temperature with addition of 8 seconds of impingement compared to 115° F. or 46.11° C. final temperature with convection alone—which is a rate that could not be matched, even when utilizing infrared at 2,000° F. (about 1,093.3° C.) for 60 seconds. (The infrared process also developed color when none was desired.) Further, the invented process could raise the core temperature in 15 seconds from 28° F. to 121° F. (−2.2° C. to 49.4° C.) when subjected to a nozzle arrangement allowing for constant or near constant steam impingement.

The patties absorbed the energy then rested in the space between the cones or nozzles. That space was being heated by the first source with contributions from the flashed-off steam previously delivered from the second source. This then allowed the patties to equilibrate as they traveled through the cook chamber on the spiral belt. Overall cook time decreased, causing cook yield to improve by 11 percent relative to the yield using the same oven at the same predetermined set point but using the conventional cooking arrangement previously described. This was attributed to the fast overall cook time from the process.

Further tests were then run to determine feasible operating conditions in a commercial oven. What was learned from those tests is, when the first and second independent heating systems are used, the total volume of impinged steam must be less than the total volume required to fully cook the product on its own using impinged steam without any convection.

Better, more consistent results are achieved if the first or primary controlling source 21 provides non-impinging flow and the second or secondary source 31 provides impinging flow. If the second source 31 controls the first source 21, the effect on the product tends to be inconsistent because every time the cook chamber 10 reaches its predetermined set point, impinging flow reduces until the measured state of the cook chamber 10 drops below the set point. Starting and stop impingement flow, or varying impingement flow, leads to variability in the finished product, including but not limited to over-cooking and under-cooking. A preferred embodiment of inventive process overcomes these problems by having the first delivery system 20, with its non-impinging flow, as the controlling delivery system or source. The second delivery system 30, which provides impinging flow, is in constant flow. In this way, two distinctly different heat sources or processes can be used in a single cook chamber without first blending the sources.

In a successful set-up example, the second delivery system 30 delivered constant impinging flow but at a flow rate of energy which allowed the first source to deliver a non-impinging flow but would not, by itself, cause the measured state of the cook chamber to reach the predetermined set point (e.g., 205° F. or about 96.1° C.). Under this setup, the modulating valve was controlling the flow rate of the first source of steam to maintain a temperature probe reading of 205° F. The steam provided by the second source 31 was at 40 PSI and 287° F. (about 141.7° C.), with the outlet of the nozzle suspended ¼ inch (0.635 cm) above the top surface of the patty.

In this example the steam was being delivered from each delivery system 20, 30 at the same line pressure but the practical effect was that energy from the first source 21 of steam had a reduced impact on the product due to the fact that it was dispersed into the atmospheric pressure environment and lost energy relative to the second source's 31 capacity. However, note the first and second delivery systems 20, 30 could have different delivery pressures. Also, the measured state of the cook chamber 10, and the predetermined set point, could be something other than temperature, including but not limited to relative humidity, dew point, wet-bulb temperature, water vapor content, oxygen level, and pressure.

The steam exiting the nozzle 33 first contacted the top surface of the patty before some of the steam “flashed off” of the surface. This flashed-off steam then mixed with the steam being delivered by the first delivery system 20. This two, independent-source arrangement allows the oven to take the positive characteristics of the super-heated vapor directly into the surface of the product without losing energy initially to the cooking chamber 10 by the impingement process.

In other words, the steam energy here has two contributors. Firstly, just before exiting the nozzle 33 the steam will typically be above the boiling point (212° F. or 100° C.) and in a range of dry saturated steam to super-heated vapor. Depending on pressure, the temperature will vary. During operation a fixed pressure is preferred, or within a reasonable tolerance, so as not to negatively affect the product. Secondly, after the impingement steam has been delivered from the nozzle 33 to the product, it is released to the cooking atmosphere, allowing its remaining energy to be utilized while being circulated through the cooking chamber 10.

The benefits of this approach can be repeated by having, as part of the second source 31 or delivery system 30, numerous cones or nozzles 33 located at regular or intermittent locations above and below the belt. The biggest impact is on the surface of the product.

Alternate preferred embodiments of the above approach include but are not limited to a second delivery system 30 that:
a. injects steam into a high-temperature spiral oven or linear oven where the operating temperature is above 212° F. (100° C.) and perhaps as high as 650° F. (about 343.3° C.); or
b. injects a dry air at a predetermined temperature and condition to dry the surface of the product or to sear or blister it; or
c. injects a fluid medium onto the surface of the product within a radiant wall oven or high-temperature continuous oven with infrared or refracted energy; or
d. impinges direct flame onto the surface of the product to provide additional energy, or to produce color or flavor associated with flame cooking; or
e. injects a wood smoke or similar smoke supply medium to impart flavor to, dry, or cure.

By way of a non-limiting example, superheated vapor can be directed onto the product at a temperature greater than the operating temperature. The oven could be running at 450° F. (about 232.2° C.) and the superheated vapor could be directed onto the product at a temperature of slightly above the oven temperature (e.g. 475° F., or about 246.1° C.), about 30% above it (e.g., 600° F. or about 315.6° C.), or more than double the oven temperature (e.g., 1,000° F. or 537.8° C.). Regardless of the actual temperature difference selected, the objective is to capture the energy of the higher temperature superheated vapor onto the product as it collapses to the operating temperature of the oven.

Another non-limiting example is the operating temperature of the oven could be 200° F. (about 93.3° C.), wet steam or humidity, with superheated vapor at about four times the oven temperature (e.g., 800° F. or about 426.7° C.) collapsing into the oven. The superheated vapor is directed onto the product being heat-treated or cooked or seared.

Additionally, the energy source injected into the secondary heating system can be blended to include smoke—natural, liquid, cloud, or some combination thereof—such as that produced by Red Arrow Products (Manitowoc, Wis.).

What is claimed:

1. A method for cooking food product in an oven, the method comprising the steps of:
delivering a first cooking medium into a cook chamber of the oven;
delivering a second cooking medium into the cooking chamber of the oven;
the delivery of the first cooking medium being dependent on a measured state of the cook chamber relative to a predetermined set point of the cook chamber, the delivery of the second cooking medium being independent of the measured state of the cook chamber relative to the predetermined set point.

2. A method according to claim 1 wherein the first and second cooking mediums each originate from a different source of cooking medium.

3. A method according to claim 1 wherein the first and second cooking mediums originate from a same source of cooking medium.

4. A method according to claim 1 wherein the second cooking medium when being delivered into the cook chamber is at a different temperature than the first cooking medium.

5. A method according to claim 1 wherein the second cooking medium when being delivered into the cook chamber is at a higher temperature than a temperature of the cook chamber.

6. A method according to claim 1 wherein the second cooking medium when being delivered into the cook chamber is at a different pressure than that of the first cooking medium.

7. A method according to claim 1 wherein delivery of the first cooking medium is a non-impinging flow and the delivery of the second cooking medium is an impinging flow.

8. A method according to claim 1 wherein the delivery of the second cooking medium continues when the state of the cook chamber reaches or exceeds the predetermined set point.

9. A method according to claim 1 wherein the delivery of the second cooking medium cannot cause the measured state of the cook chamber to rise above the predetermined set point.

10. A method according to claim 1 wherein after being delivered an unabsorbed portion of the second cooking medium combines in the cook chamber with a delivered portion of the first cooking medium

11. A method according to claim 1 wherein at least one of the first and second cooking mediums is steam in a range of saturated steam to super-heated steam.

12. A method according to claim 1 wherein the measured state is a temperature.

13. A method according to claim 1 wherein the predetermined set point is a temperature.

14. A method according to claim 1 wherein the second cooking medium is includes a smoke product.

15. A system for use in a commercial oven, the system comprising:
a first delivery system in communication with a first source of cooking medium and arranged to deliver the first source of cooking medium into a cook chamber of the commercial oven;
a second delivery system in communication with a second source of cooking medium and arranged to deliver the second source of cooking medium into the cook chamber;
means for controlling the delivery of the first source of cooking medium relative to a measured state of the cook chamber and a predetermined set point of the cook chamber;
means for controlling the delivery of the second source of cooking medium, the measured state of the cook chamber and the predetermined set point not affecting the delivery of the second source of cooking medium.

16. A system according to claim 15 wherein the first and second cooking medium sources are each from a different supply of cooking medium.

17. A system according to claim 15 wherein the first and second cooking medium sources are from a same supply of cooking medium.

18. A system according to claim 15 further comprising at least one of the first and second delivery systems being arranged for non-impinging flow of a respective cooking medium.

19. A system according to claim 15 further comprising at least one of the first and second delivery systems being arranged for an impinging flow of a respective cooking medium.

20. A system according to claim 15 wherein the second cooking medium is at a higher temperature than a temperature of the cook chamber.

21. A system according to claim 15 wherein the measured state is a temperature.

22. A system according to claim 15 wherein the predetermined set point is a temperature.

23. A system according to claim 15 wherein the second cooking medium includes a smoke product.

24. A commercial oven comprising:
a first delivery system arranged to deliver a first cooking medium in a non-impinging flow pattern into a cook chamber of the commercial oven;
a second delivery system arranged to deliver a second cooking medium in an impinging flow pattern into the cook chamber;
a first means for controlling the first delivery system relative to a measured state of the cook chamber and a predetermined set point of the cook chamber; and
a second means for controlling the second delivery system independent of the measured reading of the cook chamber and the predetermined set point;
wherein the second means for controlling limits delivery of the second cooking medium so as not to exceed the predetermined set point by itself.
